(19) United States
(12) Patent Application Publication
(10) Pub. No.: US 2013/0041581 A1
(43) Pub. Date: Feb. 14, 2013

(54) COMMON POINT OF INTEREST ("POI") IDENTIFICATION SYSTEM

(71) Applicant: Edward D. Tate, JR., Grand Blanc, MI (US)

(72) Inventor: Edward D. Tate, JR., Grand Blanc, MI (US)

(73) Assignee: GM GLOBAL TECHNOLOGY OPERATIONS LLC, Detroit, MI (US)

(21) Appl. No.: 13/206,903

(22) Filed: Aug. 10, 2011

(51) Int. Cl. G01C 21/34

(52) U.S. Cl. 701/422; 701/426

(57) ABSTRACT

A system and method of determining a geographically reachable area is provided. A vehicle is in communication with a network. The network is in communication with at least one other vehicle. The method includes establishing communication between the vehicle and at least one other vehicle through the network. The method includes determining a travel range for the vehicle and a travel range for the at least one other vehicle. The method includes comparing the travel range for the at least one other vehicle with the travel range for the vehicle. The method includes determining where the travel range for the at least one other vehicle and the travel range for the vehicle overlap. The method further includes identifying the geographically reachable area by both the vehicle and the at least one other vehicle.

### FIELD OF THE INVENTION

Exemplary embodiments of the invention relate to a system for determining a geographically reachable area and, more particularly to a system associated with a vehicle for identifying a geographically reachable area by both the vehicle and at least one other vehicle.

### BACKGROUND

It is often the case that multiple individuals who are all situated in different locations want to meet in a common location for an event such as, for example, a business meeting, lunch, or for socializing. The common location may be referred to as a common point of interest (“POI”), and is any type of location such as, for example, an office building or a restaurant.

Sometimes it is difficult to determine a common POI that is convenient or accessible for all individuals. In particular, it may be challenging to define a common POI taking into account each individual's specific travel restraints. For example, each individual may have his or her own set of constraints such as travel time or distance. Determining a common POI may become especially challenging if some or all individuals have a limited range powertrain vehicle such as an extended-range electric vehicle (“EREV”) or a battery electric vehicle (“BEV”), which have a limited electric range. Accordingly, it is desirable to provide an approach identifying a common POI that is attainable by several individuals.

### SUMMARY OF THE INVENTION

In one exemplary embodiment of the invention, a system and method of determining a geographically reachable area is provided. A vehicle is in communication with a network. The network is in communication with at least one other vehicle. The method includes establishing communication between the vehicle and the other vehicle through the network. The method includes determining a travel range for the vehicle and a travel range for the other vehicle. The method includes comparing the travel range for the other vehicle with the travel range for the vehicle. The method includes determining where the travel range for the other vehicle and the travel range for the vehicle overlap. The method further includes identifying the geographically reachable area by both the vehicle and the other vehicle. The geographically reachable area is the where the travel range for the other vehicle and the travel range for the vehicle overlap. The method includes providing an indication of the geographically reachable area.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 is a is a schematic diagram of an exemplary common point of interest (“POI”) identification system employed in a vehicle;

FIGS. 2A-2B illustrate various travel ranges calculated by the POI identification system shown in FIG. 1, where FIG. 2A illustrates four different travel ranges and FIG. 2B illustrates the intersection between the four different travel ranges illustrated in FIG. 2A;

FIG. 3 is an alternative embodiment of the POI identification system shown in FIG. 1; and

FIG. 4 is an illustration of a process flow diagram illustrating defining a common POI by the POI identification system illustrated in FIG. 1.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features. As used herein, the term module refers to an application specific integrated circuit (ASIC), an electronic circuit, a processor (shared, dedicated, or group) and memory that executes one or more software or firmware programs, a combinational logic circuit, and/or other suitable components that provide the described functionality.

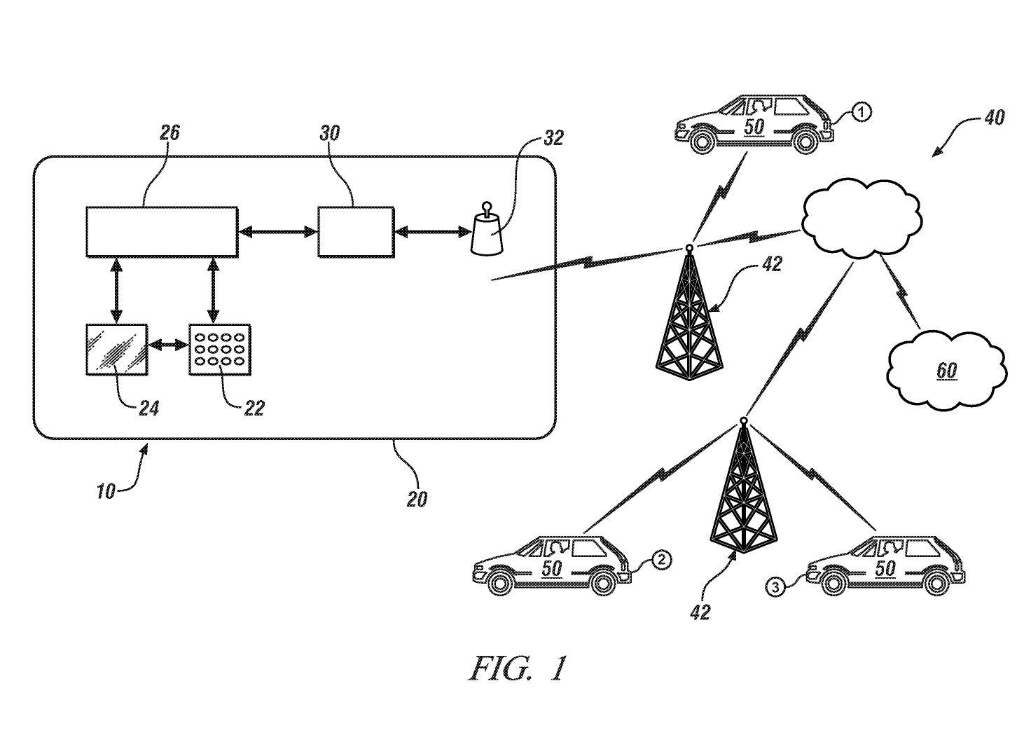

Referring now to FIG. 1, an exemplary embodiment is directed to a common point of interest (“POI”) identification system 10. The POI identification system 10 is associated with a unique vehicle 20. The POI identification system 10 includes a user input 22, a display 24, a control module 26, a transceiver 30, and an antenna 32. In the exemplary embodiment as shown in FIG. 1, the control module 26 is a vehicle control module such as, for example, an infotainment control module or a navigation control module. The antenna 32 of the POI identification system 10 is in communication a wireless communication network 40. For example, in the embodiment as shown, the network 40 is a cellular network that includes several cellular sites 42 where antennas and electronic communications equipment are placed. The network 40 connects the POI identification system 10 with at least one other vehicle 50. As shown in FIG. 1, the network 40 connects the POI identification system 10 with three other vehicles 50, which are labeled as ‘1’, ‘2’, and ‘3’. The other vehicles 50 also include their own POI identification systems (not shown) as well.

The control module 26 receives data signals from the network 40 through the antenna 32 and the transceiver 30. The control module 26 is in communication with the user input 22, the display 24, the transceiver 30 and the antenna 32. Although FIG. 1 illustrates the transceiver 30 and the antenna 32 as separate components from the control module 26, it is to be understood that the transceiver 28 and the antenna 30 may also be integrated with the control module 26 as well. The user input 22 typically includes a keypad or a keyboard for allowing a user to input information. In one embodiment, the display 22 is a liquid crystal display (“LCD”) screen, and is used to display graphics and text. Although FIG. 1 illustrates the user input 22 and the display 24 as separate components it is to be understood that the user input 22 and the display 24 may be a combined unit as well. For example, in another embodiment the display may be a touchscreen that detects the presence and location of a user's touch.

Determination of which vehicle or vehicles 50 to include with the POI identification system 10 may be accomplished using a variety of approaches. That is, a variety of different approaches currently exist for determining the other vehicles 50 that are in communication with the POI identification system 10 of the vehicle 20. In one exemplary embodiment of the POI identification system 10, each of the vehicles 20 and 50 are connected to the Internet, and are logged into a specific Internet website that includes an application for determining the other vehicles 50 that are in communication with the POI identification system 10. In another embodiment, a user may manually select the vehicles 50 by browsing through a list of contacts that are stored in a memory of the control module 26. Alternatively, a user may browse through a list of contacts that are on a remotely located computer (not shown) located over a network cloud 60. Specifically, the control module 26 is in communication with the network cloud 60, where the control module 26 acts as a thin client. A thin client is typically a computing device that acts as an access device on a network. Specifically, a thin client connects over a network (such as network 60) to a remotely located computer. In one embodiment, a majority of the processing needed to execute an application usually takes place on the server.

The control module 26 may be in communication with or includes a global positioning satellite (“GPS”) receiver that is in communication with a satellite (not shown) for providing information regarding the location of the vehicle 20. Alternatively, in another embodiment, the location of the vehicle 20 may be determined by obtaining user input. Specifically, a user may input location information into a keypad or keyboard of the user input 22. In one embodiment, the control module 26 includes an application for defining a common POI that is shared between each of the vehicles 20 and 50 illustrated in FIG. 1. The application may be a program that is included with the control module 26 at the time of manufacture. Alternatively, the application may be a downloadable application that is saved on the memory of the control module 26 after manufacture of the vehicle 20 as well. In yet another embodiment, the application is stored on a remotely located computer (not shown) located over the network cloud 60, where the control module 26 acts as a thin client.

In one embodiment, the control module 26 includes control logic for determining the travel range for the vehicle 20. Alternatively, the control module 26 may act as a thin client, where determination of the travel range is performed remotely. For example, in one embodiment, the determination of the travel range is performed over the network cloud 60, and is sent to the control module 26 through the network 40. The travel range is the distance the vehicle 20 may travel based on at least one factor or constraint. The constraint may be, for example, a distance, a travel time, or an energy range. For example, if a user wanted to set the travel range of the vehicle 20 based on travel time, the user may input a travel time through the user input 22. Alternatively, the user may also set the travel range of the vehicle 20 based on a distance such as. In another embodiment, the user may set the travel range based on energy as well. For example, in the event the vehicle 20 is an extended-range electric vehicle (“EREV”) or a battery electric vehicle (“BEV”), the travel range of the vehicle 20 is based electrical energy. Specifically, the user may set the travel range based on travel energy such as, for example, an amount of energy based on kilowatt hours (kWHr).

In one embodiment, the control module 26 includes control logic for monitoring the network 40 for data signals indicating the travel range of the other vehicles 50. The other vehicles 50 include respective POI identification systems (not shown) that are in communication with the network 40. The vehicles 50 are in communication with the network 40 through respective antennas (not shown), where a user of each vehicle 50 sets a travel range of the respective vehicle 50. The control module (not shown) of each respective vehicle 50 includes control logic for calculating a travel range, for example, of the respective vehicle 50. The data signals indicating the travel range of the other vehicles 50 are sent through the network 40 and to the control module 26 through the antenna 32. Alternatively, in another embodiment, the control module 26 includes control logic for receiving information over the network 40 from the control module (not shown) regarding each respective vehicle 50, and calculates the travel range of each respective vehicle 50. In yet another embodiment, the control module 26 acts as a thin client, where calculation of the travel ranges of the other vehicles 50 is done remotely and then sent to the control module 26 through the network 40.

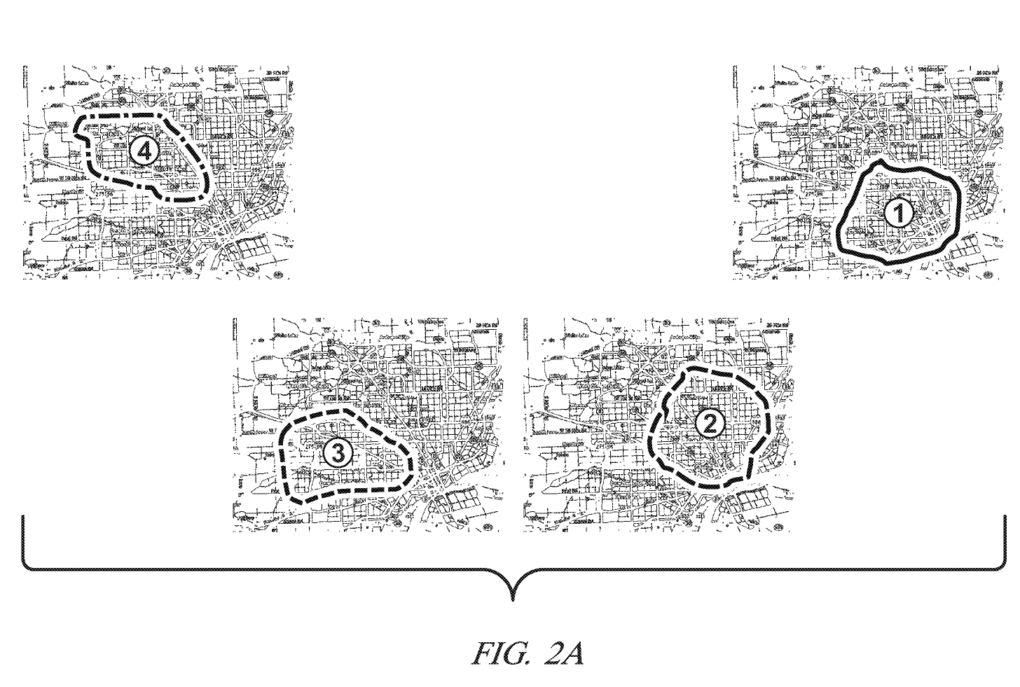

FIG. 2A is a graphical representation of illustrating a travel range for each vehicle 50 as well as the vehicle 20. For example, referring to both FIGS. 1 and 2A, the travel range labeled ‘1’ in FIG. 2A corresponds to the vehicle 50 labeled as ‘1’ in FIG. 1. The travel range labeled ‘2’ in FIG. 2A corresponds to the vehicle 50 labeled as ‘2’ in FIG. 1. The travel range labeled ‘3’ in FIG. 2A corresponds to the vehicle 50 labeled as ‘3’ in FIG. 1. The travel range labeled ‘4’ in FIG. 2A corresponds to the vehicle 20 in FIG. 1. The travel range for each vehicle 20 and 50 may be displayed on the corresponding display. For example, the control module 26 includes control logic for creating graphical data based on the travel range of the vehicle 20, where the graphical data is shown on the display 24 as the travel range label ‘4’ in FIG. 2A.

In one embodiment, the control module 26 further includes control logic for comparing the travel ranges of each of the vehicles 50 and the vehicle 20, and determining where the travel ranges of the vehicles 20 and 50 overlap. Alternatively, in another embodiment the control module 26 acts as a thin client, where determination of where the travel ranges of the vehicles 20 and 50 overlap is calculated remotely, and sent to the control module 26. Specifically, referring now to FIG. 2B, the travel ranges of each of the vehicles 1, 2, 3, and 4 in FIG. 2A are compared, and an area of overlap referred to as reference number 62 (FIG. 2B) is determined. The area of overlap 62 represents a geographically reachable area by all of the vehicles 20 and 50 shown in FIG. 1. The area of overlap 62 includes a variety of different POIs. The POIs may be any type of location where multiple individuals may meet such as, for example, a bar, a restaurant, a movie theatre, or an office building. The control module 26 may include control logic for determining the POIs located within the area of overlap 62. That is, in one embodiment the control module 26 includes control logic for determining which POIs located in the area of overlap 62 are accessible to the users of vehicles 20 and 50 (shown in FIG. 1). The control module 26 may include control logic for creating graphical data representing the area of overlap 62, where the graphical data is shown on the display 24. Alternatively, in another embodiment the control module 26 acts as a thin client, where the POIs are determined remotely and sent to the control module 26 over the network 40.

Continuing to both FIGS. 1 and 2B, in one embodiment the control module 26 includes control logic for monitoring both the network 40 and the user input 22 for data indicating a defined type of POI. Specifically, in one embodiment the control module 26 includes control logic for displaying a list of available POIs that are located within the area of overlap 62 on the display 24. The control module 26 may also include control logic for monitoring the user input 22 for data signals indicating a defined type of POI that is inputted by a user. The control module 26 also includes control logic for monitoring the network 40 to determine the defined type of POI that is defined by the users of the vehicles 50. Alternatively, in another embodiment, the list of POIs may be stored remotely on a remotely located computer (not shown) located over the network cloud 60, where the control module receives information over the network 40 indicating the list of POIs. The remote computer (not shown) may also monitor the network 40 for information indicating the defined type of POI that is defined by the users of the vehicles 50.

The users may define the POI to meet their particular preferences. For example, if the users of the vehicles 20 and 50 wanted to all meet at a restaurant, each user may input his or her preference for a particular type of restaurant. Specifically, in one illustrative embodiment, the user of the vehicle ‘1’ may enter ‘ALL’ for restaurant type because he or she may have no preference, the user of the vehicle ‘2’ may enter ‘Asian’ for his or her preference, the user of vehicle ‘3’ may enter ‘Thai’ for his or her preference, and the user of vehicle ‘4’ may enter ‘ALL’.

A common POI based on the input of each of the users of the vehicles 20 and 50 is then defined. In the example discussed above, because a Thai restaurant is a specific type of Asian restaurant, a Thai restaurant within the area of overlap 62 would be selected in the event if a Thai restaurant is available. This is because a Thai restaurant as the common POI would fulfill every user's selection in the example as discussed.

In one embodiment, the control module 26 includes control logic for comparing the common POI defined by the POI identification system 10 with the common POI defined by the other vehicles 50. Specifically, the control module 26 compares the common POIs in an effort to confirm that all of the vehicles 20 and 50 have defined the same location as the common POI. The control module 26 includes control logic for monitoring the network 40 for data signals indicating the common POI that is defined by the respective POI identification systems (not shown) of the other vehicles 50. The control module 26 includes control logic for determining if the common POI defined by the POI identification system 10 represents the same location as the POI defined by the respective POI identification systems that are associated with the other vehicles 50 in an effort to ensure all of the vehicles 20 and 50 meet at the same location. Alternatively, in another embodiment, the control module 26 acts as a thin client, where comparison of the common POIs in an effort to confirm that all of the vehicles 20 and 50 have defined the same location as the common POI is performed by a remotely located computer (not shown in FIG. 1), and then sent to the control module 26 through the network 40. The control module 26 also includes control logic for providing navigational information from the current location of the vehicle 20 to the common POI, or may act as a thin client that receives navigational information over the network 40.

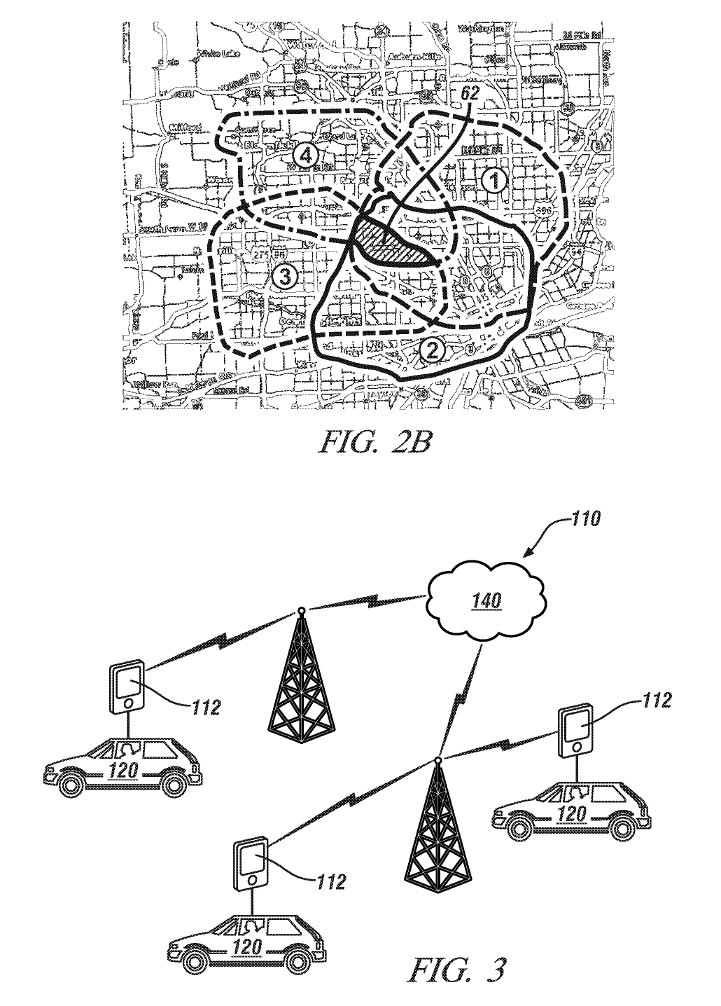

Although FIG. 1 illustrates the POI identification system 10 being executed by a vehicle control module 26 or acting as a thin client that receives communication from a remotely located computer (not shown in FIG. 1), it is understood that the POI identification system 10 may be executed by, or is in communication with, a remotely located computer by other types of electronic devices as well. For example, FIG. 3 is an alternative embodiment of a POI identification system 110 that is part of a personal electronic device 112. The personal electronic device 112 is typically any type of portable consumer electronic device that has wireless communication capabilities such that communication with a network 140 is possible. For example, in the embodiment as illustrated, the personal electronic device 112 may be a smartphone. The POI identification system 110 is associated with a unique vehicle 120.

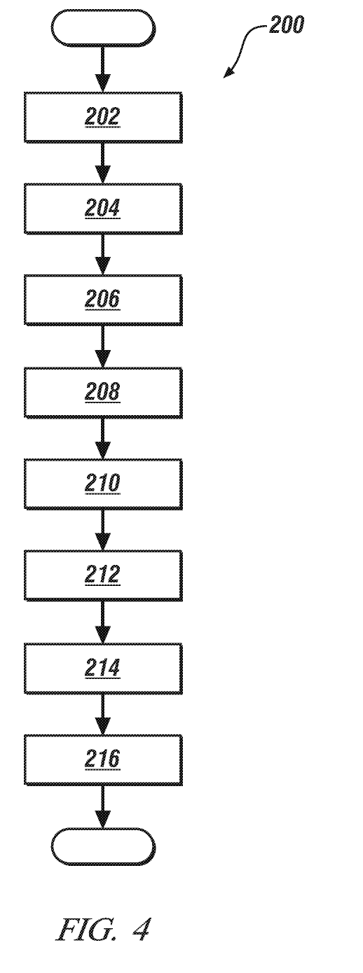

Operation of the POI identification system 10 will now be explained. Turning now to FIG. 4, a process flow diagram illustrating a method of defining a common POI by a POI identification system 10 is indicated by reference number 200. Referring generally to FIGS. 1-4, process 200 begins at step 202, where communication is established between the vehicle 20 and at least one other vehicle 50. Referring specifically to FIG. 1, an antenna 32 of the POI identification system 10 is in communication with a network 40. The network 40 connects the POI identification system 10 with at least one other vehicle 50. In the embodiment as shown in FIG. 1, the network 40 connects the POI identification system 10 with three other vehicles 50, which are labeled as ‘1’, ‘2’, and ‘3’. The other vehicles 50 also include their own POI identification systems (not shown) as well. Process 200 may then proceed to step 204.

In step 204, a travel range of the other vehicles 50 is calculated. As described above, the control module (not shown) of each respective vehicle 50 may include control logic for calculating a travel range of the respective vehicle 50. The data signals indicating the travel range of the other vehicles 50 are then sent through the network 40 and to the control module 26 through an antenna 32. Alternatively, in another embodiment, the control module 26 includes control logic for receiving information over the network 40 from the control module (not shown) regarding each respective vehicle 50, and calculates the travel range of each respective vehicle 50. In yet another embodiment, the control module 26 acts as a thin client, where calculation of the travel ranges of the other vehicles 50 is done remotely, and then sent to the control module 26. Process 200 may then proceed to step 206.

In step 206, the travel range of the vehicle 20 is determined. Specifically, referring to FIG. 1, the control module 26 includes control logic for determining the travel range for the vehicle 20 based on the location of the vehicle 20. The travel range is the distance the vehicle 20 may travel based on at least one factor or constraint. The constraint may be, for example, a distance, a travel time, or an energy range. Alternatively, the control module 26 may act as a thin client, where determination of the travel range is performed remotely. Process 200 may then proceed to step 208.

In step 208, the travel range of the vehicle 20 is compared to the other vehicles 50 to calculate where the travel ranges overlap. Specifically, referring to FIGS. 2A-2B, in one embodiment the control module 26 compares the travel ranges of each of the vehicles 1, 2, 3, and 4 in FIG. 2A, and determines an area of overlap 62. The area of overlap 62 represents a geographically reachable area by all of the vehicles 20 and 50 that are shown in FIG. 1. The area of overlap 62 includes a variety of different POIs. Alternatively, the control module 26 may act as a thin client, where determination of the travel range of the other vehicles 50 are performed remotely. Process 200 may then proceed to step 210.

In step 210, the POIs located within the area of overlap 62 are determined. That is, in one embodiment the control module 26 includes control logic for determining which POIs are accessible to the users of vehicles 20 and 50 (shown in FIG. 1). Alternatively, in another embodiment the control module 26 acts as a thin client, where the POIs are determined remotely and sent to the control module 26 over the network 40. Process 200 may then proceed to step 212.

In step 212, both the network 40 and the user input 22 are monitored for data indicating a defined type of POI. Specifically, a list of available POIs that are located within the area of overlap 62 are shown on the display 24. The user input 22 is monitored for data signals indicating a defined type of POI inputted by a user. The network 40 is also monitored to receive the defined type of POI that is defined by the users of the vehicles 50. Process 200 may then proceed to step 214.

In step 214, a common POI located within the area of overlap 62 based on the defined type of POI by each of the users of the vehicles 20 and 50 is defined. The common POI fulfills every user's selection. Process 200 may then proceed to step 216.

In step 216, navigational information is provided from the current location of the vehicle 20 to the common POI. Process 200 may then terminate.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

What is claimed is:

1. A method of determining a geographically reachable area where a vehicle is in communication with a network, and the network is in communication with at least one other vehicle, comprising:
establishing communication between the vehicle and at least one other vehicle through the network;
determining a travel range for the vehicle and a travel range for the at least one other vehicle;
comparing the travel range for the at least one other vehicle with the travel range for the vehicle;
determining where the travel range for the at least one other vehicle and the travel range for the vehicle overlap;
identifying the geographically reachable area by both the vehicle and the at least one other vehicle, wherein the geographically reachable area is where the travel range for the at least one other vehicle and the travel range for the vehicle overlap; and
providing an indication of the geographically reachable area.

2. The method claim 1, wherein providing an indication of the geographically reachable area includes creating a set of graphical data representing the geographically reachable area that is viewed on a display.

3. The method claim 1, comprising determining a set of common points of interests (“POIs”) located within the geographically reachable area.

4. The method of claim 3, comprising including a user input associated with the vehicle, and monitoring both the network and the user input for data indicating a defined type of POI.

5. The method of claim 4, comprising defining a common POI located within the geographically reachable area based on the defined type of POI.

6. The method of claim 5, comprising providing navigational information from a current location of the vehicle to the common POI.

7. The method of claim 4, comprising determining the current location of the vehicle by one of a global positioning satellite (“GPS”) receiver and by a data set obtained from the user input.

8. The method of claim 4, wherein the defined type of POI is one of a bar, a restaurant, a movie theatre, and an office building.

9. The method of claim 1, comprising determining the travel range of the vehicle based on at least one of a travel time, travel distance, and an energy range.

10. The method of claim 9, wherein the energy range is based on an energy range of one of an extended-range electric vehicle (“EREV”) and a battery electric vehicle (“BEV”).

11. The method of claim 1, wherein the POI identification system is executable by one of a personal electronic device, a vehicle control module, and a remotely located computer situated on the network.

12. A system for calculating geographically reachable area associated with a vehicle, the system in communication with a network, the network in communication with at least one other vehicle, comprising:
a display;
a control module in communication with the network and the display, the control module comprising:
a control logic for monitoring the network and receiving a data signal that contains information indicating a travel range for the at least one other vehicle;
a control logic for determining a travel range for the vehicle;
a control logic for comparing the travel range for the at least one other vehicle with the travel range for the vehicle;
a control logic for determining where the travel range for the at least one other vehicle and the travel range for the vehicle overlap;
a control logic for identifying the geographically reachable area by both the vehicle and the at least one other vehicle, wherein the geographically reachable area is where the travel range for the at least one other vehicle and the travel range for the vehicle overlap; and
a control logic for creating a set of graphical data representing the geographically reachable area, wherein the set of graphical data is shown on the display.

13. The system of claim 12, wherein the control module includes control logic for determining a set of common points of interests (“POIs”) located within the geographically reachable area.

14. The system of claim 13, comprising a user input associated with the system, wherein the control module includes control logic for monitoring both the network and the user input for data indicating a defined type of POI.

15. The system of claim 14, wherein the control module for includes control logic for defining a common POI located within the geographically reachable area based on the defined type of POI.

16. The system of claim 15, wherein the control module includes control logic for providing navigational information from a current location of the vehicle to the common POI.

17. The system of claim 16, wherein the current location of the vehicle is determined by one of a global positioning satellite (“GPS”) receiver and by a data set obtained from the user input.

18. The system of claim 14, wherein the defined type of POI is one of a bar, a restaurant, a movie theatre, and an office building.

19. The system of claim 12, wherein the travel range of the vehicle is based on at least one of a travel time, travel distance, and an energy range.

20. The system of claim 12, wherein the control module includes control logic for calculating the travel range of the at least one other vehicle.
